(19) United States
(12) Patent Application Publication
(10) Pub. No.: US 2012/0182519 A1
(43) Pub. Date: Jul. 19, 2012

(54) Spectacles Comprising Elastically Articulated Arms

(75) Inventor: Didier Jacquemin, La Mouille (FR)

(73) Assignee: LOGO, Morez (FR)

(21) Appl. No.: 13/498,380

(22) PCT Filed: Sep. 24, 2010
(86) PCT No.: PCT/FR10/52011

§ 371 Date: Mar. 27, 2012

(30) Foreign Application Priority Data
Sep. 29, 2009 (FR) 09/56766

(51) Int. Cl. G02C 5/14

(52) U.S. Cl. 351/121

(57) ABSTRACT

Spectacles consist of an optical or solar front and two arms, each arm being connected to a frame or directly to the front by a pin and an associated elastic articulation element. The spectacles are characterized in that they comprise additional assistance devices acting beyond an equilibrium or oscillation point of the arm that is between the two support zones defining the stable positions and contributing to reinforcing the stable open position, the devices being formed by at least one magnetic element integrated into one or the other of the supporting zones for the pin or of the arm.

### BACKGROUND

This invention relates to spectacles of the type comprising an optical or solar front and two arms, each arm being connected to a frame or directly to the front, in the case of spectacles referred to as rimless, by means of a pin and an associated elastic articulation.

This type of articulation is, in a known manner, generally comprised of a transversal axis arranged at the end of the pin, facing the arm, and whereon is articulated a piston fixed to this arm and freely sliding in the latter by means of an elastic retaining member, according to a predetermined travel, towards an open or closed position.

This type of articulation procures a bistable effect of the arm, which has for consequence to maintain it in an open or closed position, without freely oscillating from one to the other as is the case with a conventional articulation.

This system also makes it possible to compensate for an excessive opening of the arms, and as such prevent the rupture of the latter or a plastic deformation.

Nevertheless, a disadvantage encountered with this type of articulation resides in the fact that a relatively substantial force must be exerted on the arms in order to pass from the open position to the closed position, and inversely, as the oscillation point between both of the positions is located between two supporting zones, of relatively substantial surface area, constituting the joint face between the end of the pin and the corresponding portion of the arm, in one or the other of the positions.

In order to reduce the force to be exerted on the arms, mentioned hereinabove, it was therefore first sought, according to a first phase of the inventive approach, to reduce the supporting zones, and therefore the oscillation point constituting the bistable, while still reducing the force of the spring.

But it became necessary to compensate this loss of force in order to prevent the oscillations of the arm when it arrives in open position, and secure it in this position.

### SUMMARY OF THE INVENTION

In such a way as to achieve these objectives, the invention relates to spectacles of the type comprising an optical or solar front and two arms, each arm being connected to a frame or directly to the front by means of a pin and an associated elastic articulation, of the type comprising a transversal axis arranged at the end of the pin, facing the arm, and whereon is articulated a piston fixed to the arm and freely sliding in the latter, by means of an elastic retaining member, according to a predetermined travel towards stable open or closed positions defined by the pin having two supporting zones that are substantially perpendicular to each other, constituting with the end of the arm a joint face at the closing and the opening of the latter, so as to define two corresponding stable positions, characterized in that said joint face at the opening comprises additional assistance means, acting beyond an equilibrium or oscillation point of the arm that is between the two support zones defining the stable positions and contributing to reinforcing the stable open position, said means being formed by at least one magnetic element integrated into one or the other of the supporting zones for the pin or of the arm forming the joint face at opening, in the vicinity of the axis of articulation.

The invention also relates to the characteristics that will appear in the following description, and which must be considered separately or according to all of their possible technical combinations.

### BRIEF DESCRIPTION OF THE DRAWINGS

This description provided by way of an unrestricted example, will facilitate understanding how the invention can be produced in reference to the annexed drawings wherein:

FIG. 1 shows, as a top view, an end of spectacles provided with an elastic articulation according to the invention, in stable closed position of the arm.

FIG. 2 shows the elastic articulation according to FIG. 1, after an overtravel in closing applied to the arm.

FIG. 3 is a view of the articulation, after the return of the arm to stable closed position, according to FIG. 1.

FIG. 4 is a view during the opening of the arm in oscillating position between the stable closed position, according to FIG. 1, and the stable open position.

FIG. 5 is a view of the articulation, after complete opening of the arm, in stable open position.

FIG. 6 is a view of the articulation, in a position of overtravel in opening.

FIG. 7 is a view of the articulation, after return to stable open position of the arm, according to FIG. 5.

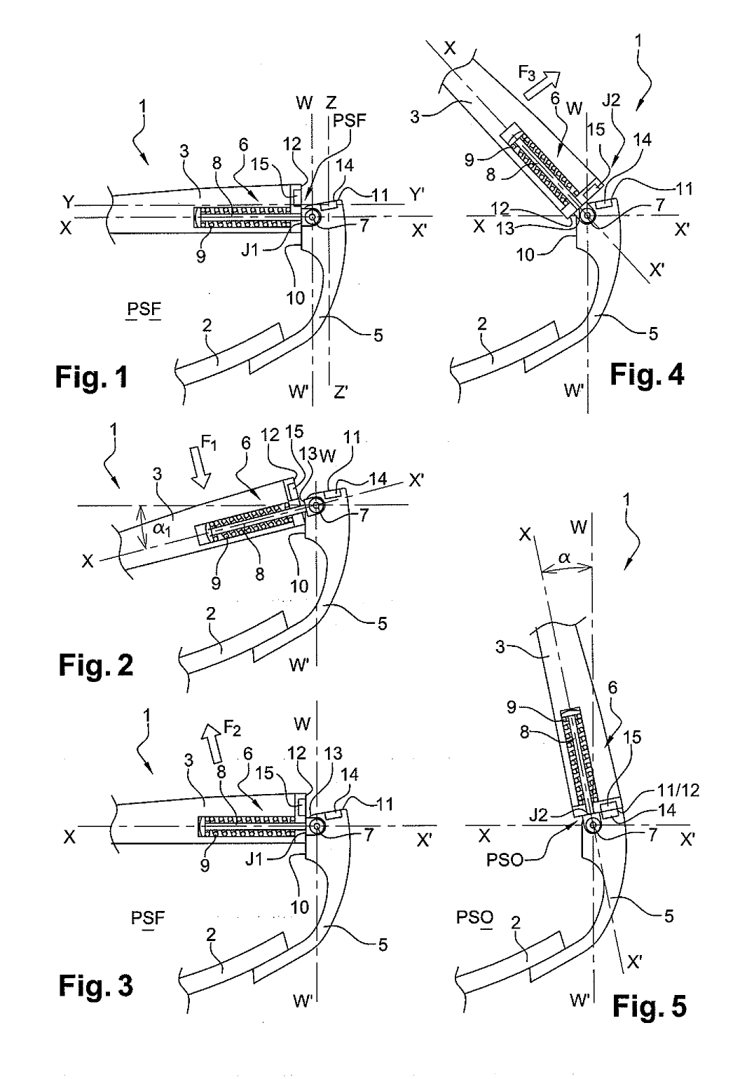

### DETAILED DESCRIPTION OF THE PREFERRED EMBODIMENT(S)

The spectacles 1 globally designated in the figures are of the type comprising an optical or solar front 2 and two arms 3, each arm being connected to a frame or directly to the front 2 by means of a pin 5 and an associated elastic articulation 6.

The elastic articulation 6 is of the type comprising a transversal axis 7 arranged at the end of the pin 5, facing the arm 3, and whereon is articulated a piston 8 fixed to the arm 3 and freely sliding in the latter, by means of an elastic retaining member 9, according to a predetermined travel towards stable open positions “PSO” or stable closed positions “PSF”.

These stable positions are defined by the pin 5 having two supporting zones 10, 11 substantially perpendicular to each other, constituting with the end 12 of the arm 3 a joint face to the closing J1 and to the opening J2 of the latter, in order to define two corresponding stable positions, respectively “PSO”, “PSF”.

According to the invention, the joint face J2 at the opening comprises additional assistance means, acting beyond an equilibrium or oscillation point 13 of the arm 3 that is between the two support zones 10, 11 defining the stable positions “PSO”, “PSF” and contributing to reinforcing the stable open position “PSO”, said means being formed by at least one magnetic element 14, 15 integrated into one or the other of the supporting zones 11 for the pin 5 or 12 of the arm 3 forming the joint face at opening J2, in the vicinity of the axis of articulation 7.

According to this embodiment, the supporting zones 11, constituting the joint face at opening J2 of the pin 5 with the arm 3 have two magnetic elements 14, 15, integrated on either side of these supporting zones.

Of course, a single magnetic element 14, 15 could be mounted only on one of the supporting zones 11, 12, across from another metal zone that can be magnetized located facing it, comprised of the arm 3 or the pin 5.

According to another characteristic of the invention, the axes “WW'” and “XX'” of the transversal articulation 7 of the pin 5 and of the piston 8 of the arm 3 which is fixed therein, by means of the elastic retaining member 9, are arranged asymmetrically in relation to the theoretical symmetrical longitudinal axes “ZZ'” and “YY'” respectively of the pin 5 and of the arm 3, in such a way as to be offset towards the interior of the arm 3, and consequently of the pin 5, in order to authorize on the one hand the material installation of the magnetic element 14, 15 in the joint face J2 towards the exterior, and obtain on the other hand a zone of stability formed by the joint face J1, of reduced surface, in closed position “PSF” of the arm 3.

Such a design was developed so that the return force of the elastic member 9 is sufficient to call the arm 3 at opening, after the user has exerted a manual pressure “F1” on the latter, in order to imply on it an overtravel in closing according to an angle α1 (see FIG. 2), having for effect to compress the elastic member 9, then by releasing said pressure “F1”, which will have for effect to release said compressed elastic member 9, as such causing not only the opening of the arm 3 by the force “F2” (see FIG. 3), but also the easy crossing of the equilibrium or oscillation point 13 (see FIG. 4), due to the zone of stability “J1”, of reduced surface, in closed position of the arm, and de of the released compression “F3” of the elastic member 9.

The opening is therefore carried out automatically and it is also facilitated by the presence of magnetic elements 14, 15 that reciprocally exert their power of attraction.

The arm 3 is then stabilized in opening (see FIG. 5).

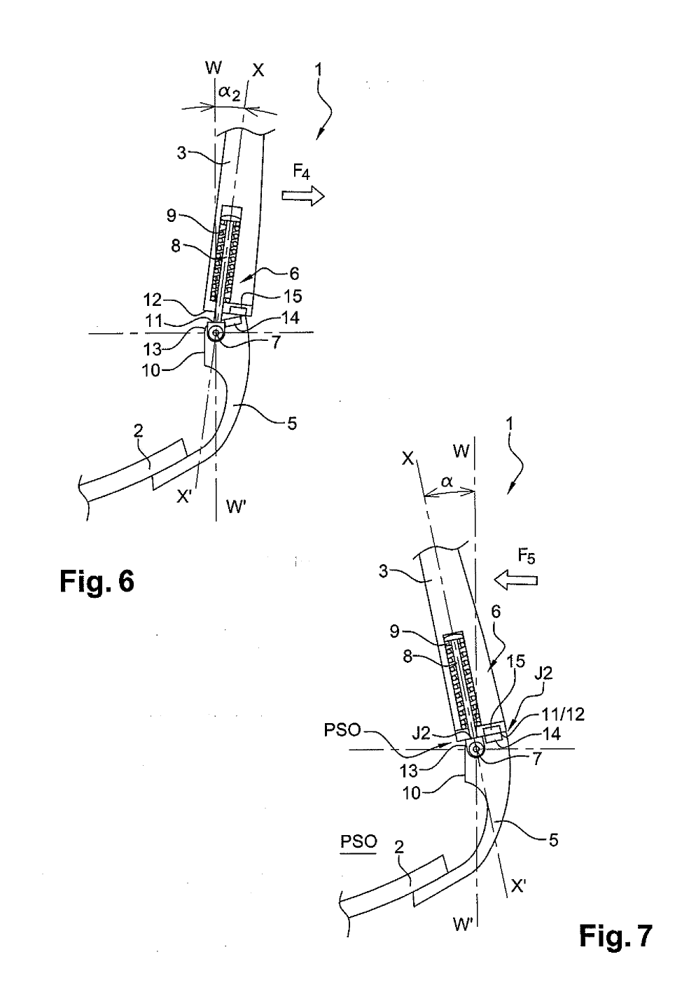

As already mentioned, in the case of overtravel according to an angle α2 (see FIG. 6) of the arm 3 in opening, caused for an occasional force “F4”, the magnetic elements 14, 15 have for role to return, according to the force “F5”, the arm 3 to its fixed open position fixe according to the angle α (see FIG. 7).

According to another characteristic of the invention, the equilibrium or oscillation point 13 of the arm 3, that is between the two support zones 10, 11 defining the stable positions “PSO”, “PSF”, is rounded in such a way as to facilitate its passage.

In this way, the inertia delivered by the elastic member 9 at the opening and the attraction of the magnetic elements 14, 15 can be developed more freely and therefore more effectively.

The presence of magnetic elements 14, 15 therefore makes it possible to obtain an automatic opening of the arms 3, but this without risk of a closing of the latter, due to the bistable effect of the articulation 6, which has just been described.

Also note that the elastic member can be comprised of a compression spring or of any other member made of elastomer or elastic extension wire or through an assembly of magnetic elements.

1-4. (canceled)

5. Spectacles comprising an optical or solar front and two arms, each said arm being connected to a frame or directly to the front by a pin and an associated elastic articulation, comprising a transversal axis arranged at an end of the pin facing a respective arm and whereon is articulated a piston fixed to the respective arm and freely sliding in the respective arm by means of an elastic retaining member according to a predetermined travel towards stable open positions or stable closed positions defined by the pin having two supporting zones that are substantially perpendicular to each other constituting with the end of the respective arm, a joint face at a closing and at an opening of the respective arm, in order to define two corresponding stable positions and said joint face at the opening comprises additional assistance means acting beyond an equilibrium or oscillation point of the respective arm that is between the two support zones defining the stable positions and contributing to reinforcing the stable open position, said additional assistance means being formed by at least one magnetic element integrated into one or the other of the supporting zones for the pin of the arm forming the joint face at opening, in a vicinity of an axis of articulation.

6. Spectacles according to claim 5, wherein the supporting zones constituting the joint face at the opening of the pin with the respective arm having two magnetic elements, integrated on either side of the supporting zones.

7. Spectacles according to claim 5, wherein axes of the transversal articulation of the pin and of the piston of the respective arm which is fixed therein, by means of the elastic retaining member, are arranged asymmetrically in relation to a theoretical symmetrical longitudinal axes respectively of the pin and of the respective arm, in such a way as to be offset towards the interior of the respective arm, and consequently of the pin, in order to authorize a material installation of the magnetic element in the joint face towards the exterior, and obtain a zone of stability formed by the joint face, of reduced surface in the closed position of the respective arm.

8. Spectacles according to claim 5, wherein the equilibrium or oscillation point of the respective arm that is between the two support zones defining the stable positions is rounded in such a way as to facilitate its passage.
